(19) United States
(12) Patent Application Publication
(10) Pub. No.: US 2011/0041157 A1
(43) Pub. Date: Feb. 17, 2011

(54) Systems and Methods for Selecting Content For a Subscriber of a Content Service Provider

(75) Inventors: Charles H. Dasher, Lawrenceville, GA (US); Alan S. Rouse, Lawrenceville, GA (US); David G. Griffith, Alpharetta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television Inc.

(21) Appl. No.: 12/540,636

(22) Filed: Aug. 13, 2009

(51) Int. Cl. H04N 7/173

(52) U.S. Cl. 725/98

(57) ABSTRACT

Various embodiments of the present invention provide systems and methods for selecting content for a subscriber of a video service provider. In particular embodiments, the systems and methods provide a personalized playlist that includes one or more titles of content that have been specifically identified for the subscriber. Further, in various embodiments, the systems and methods transmit a selected content from the playlist over a unicast stream to the subscriber. In various embodiments, the playlist is provided to the subscriber through a content provider's environment such as video on demand (VOD) service.

### BACKGROUND OF THE INVENTION

1. Field of the Invention

The disclosed invention generally relates to systems and methods for selecting content for a subscriber of a video service provider, and more specifically, to systems and methods for providing a personalized playlist that includes one or more titles of content that have been specifically identified for the subscriber and transmitting a selected content from the playlist over a unicast stream to the subscriber.

2. Description of the Related Art

Subscribers are accustomed to broadcast type video services wherein selection of broadcast video content is performed by the service provider (e.g., programmer or operator) and the subscribers view the broadcast. Currently, when a subscriber watches television, the subscriber watches a linear channel that is broadcast to all subscribers at the same time. In many cases, personalization of this broadcast stream is not possible without costly implementation and equipment by the service provider (such as video splicing and multiplexing equipment).

Many of these content service providers have also invested heavily installing interactive video infrastructure, such as video on demand service (VOD), into their existing systems. VOD services allow subscribers to select from a catalog of videos (and other content) to watch that appeals to them on their own time schedule. Therefore, it is desirable by many service providers to allow personalization of a viewed video stream by leveraging the service provider's existing infrastructure.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a flow diagram illustrating the process for selecting content for a subscriber according to various embodiments of the invention.

FIG. 2 is a schematic diagram illustrating a cable service provider's system according to various embodiments of the invention.

FIG. 3 is a schematic diagram illustrating a personalized content server according to various embodiments of the invention.

FIG. 4 is a schematic diagram illustrating a set-top box according to various embodiments of the invention.

FIG. 5 is a flow diagram of a profile module according to various embodiments of the invention.

FIG. 6 is a flow diagram of a recommendation module according to various embodiments of the invention.

FIG. 7 is a flow diagram of a set-top box module according to various embodiments of the invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Like numbers refer to like elements throughout.

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### Brief Overview of an Embodiment

Various embodiments of the present invention provide systems and methods for selecting content specifically for a subscriber in a content provider environment, such as a cable service provider and/or satellite TV provider. Further, in various embodiments, this entails the systems and methods providing a playlist of titles for one or more content items that may appeal to the subscriber and streaming a selected content item from the playlist to the subscriber over a unicast stream. A “content item” is a particular piece of media content. For instance, a content item may be a television program, a movie, and/or a radio program. Furthermore, the term “provider” is used from this point forward to indicate a cable service provider, a satellite TV provider, or any other provider of distributed media content.

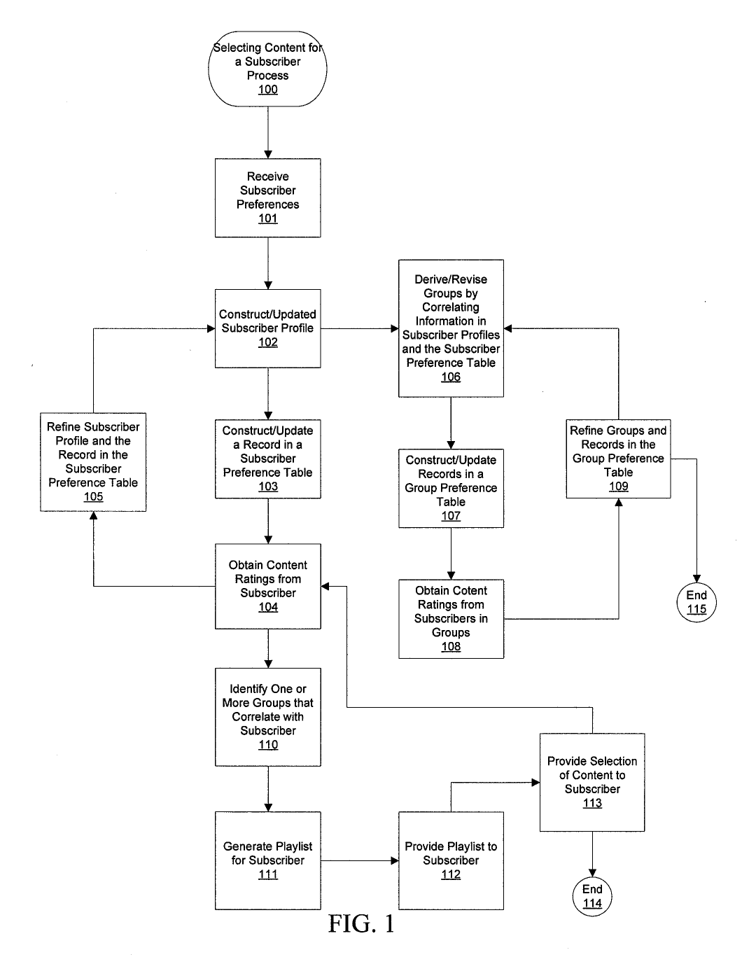

FIG. 1 illustrates one embodiment of a flow diagram of a process 100 for selecting content specifically for a subscriber. In various embodiments, the subscriber is provided a playlist of titles for content items generated specifically for the subscriber. For instance, in one embodiment, the subscriber enters the VOD service through the subscriber's set-top box and the personalized playlist is provided as an option. Thus, the subscriber can bring up the playlist and select a content item, such as a movie, to view.

In various embodiments, the content items selected for a subscriber's playlist are based on particular preferences of the subscriber and/or particular preferences of groups of subscribers with similar tastes as the subscriber. Thus, the content items are selected for the subscriber's playlist based on a prediction that the subscriber will like the content items.

Thus, the process 100 begins at Step 101 with the service provider receiving the subscriber's preferences. For instance, in one embodiment, the subscriber is provided with one or more screens through the provider's VOD service that allows the subscriber to enter information related to the subscriber's preferences. For example, these screens may entail a number of questions such as “how much do you like westerns?” or more specific questions such as “how much did you like the movie ‘Star Wars?’” The provider may ask the subscriber to response with some type of indicator. For example, a number between one and ten with ten representing the highest rating. Further, in various embodiments, the questions may be more involved such as “provide a listing of your five favorite actors and a rating for each actor on a scale from one to ten on how well you like the actor.”

In other embodiments, the subscriber logs onto a web site that is in communication with the subscriber's system and enters his or her preferences. For instance, in these particular embodiments, the subscriber accesses the web site over the Internet and enters an identifier for the subscriber. For example, the subscriber may enter in his or her account number on the web site or the subscriber may enter in his or her account number along with his or her name so that preferences may be collected for multiple subscribers under one account (e.g., subscribers that live in the same household). Once the subscriber has identified himself or herself, the subscriber enters his or her preferences into various screens provided on the web site in a similar fashion as through the VOD services.

In addition, in various embodiments, the subscriber's viewing habits (e.g., historical program selections) may also be collected as an indication of the subscriber's preferences. This information may be used in conjunction with the information received directly from the subscriber or may be used instead of the information received directly from the subscriber.

In Step 102, a subscriber profile is constructed or updated for the subscriber based on the information collected on the subscriber's preferences. Thus, in various embodiments, the profile includes general information about the subscriber, such as the subscriber's name, home address and/or location within the provider's service area, and account number. In addition, the profile includes information on the subscriber's preferences, such as, for example, television programs and/or movies the subscriber has watched and ratings the subscriber has given these television programs and movies.

In various embodiments, the profile is stored at a central location within the provider's system so that the profile may be used in conjunction with various other aspects of the system as is described in further detail below. However, in other embodiments, the subscriber's profile may be stored locally on the subscriber's set-top box.

From the subscriber's profile, the provider constructs or updates a record for the particular subscriber to store in a subscriber preference table, shown as Step 103. In various embodiments, the record included in the preference table comprises one or more categories and scores for each category representative of the subscriber's like and dislike for the category. As is described in greater detail below, these scores are used to determine what content items to include on the subscriber's playlist. For instance, the subscriber's record may include a category for comedies and the category may have a high score relative to the other categories listed in the record. Thus, the provider may be inclined to select content items that fall into the category of comedies to include on the subscriber's playlist.

Further, in Step 104, the process 100 continues with obtaining content ratings from the subscriber on content (e.g., television programs and movies) the subscriber has viewed. Thus, in various embodiments, the subscriber is provided with a screen at the end of each program in which the subscriber can enter a rating for the program the subscriber has just viewed. For example, the screen may ask the subscriber to enter a number from one to ten on how much the subscriber liked the program with ten being the highest rating. In other embodiments, the subscriber may be asked more than one question and/or asked more involved questions. For instance, the program may have starred a particular actor and the provider may ask the subscriber whether he or she is a fan of the particular actor. In another instance, the subscriber may be asked a more involved question such as name any actors who appeared in the program that he or she a fan of and provide a rating for the particular actor. Thus, the subscriber is asked a question and the subscriber uses various mechanisms for entering a response, such as the subscriber's remote control or a keyboard in communication with the subscriber's set-top box. In various embodiments, this type of questioning is an ongoing process for updating and refining profiles and preference records.

Thus, in various embodiments, the subscriber's profile and record in the subscriber preference table may be refined based on the collected ratings, shown as Step 105. The subscriber's profile may include information on the viewed programs along with his or her ratings and one or more scores for categories stored in the subscriber's record in the subscriber preference table may be updated based on the newly acquired ratings. As a result, the subscriber's record in the preference table may be refined over time and may better represent the subscriber's preferences.

In addition, in various embodiments, groups of subscribers may be derived (or revised) by correlating information found in subscriber profiles and/or records in the subscriber preference table, shown as Step 106. As is described in further detail below, these groups are used to identify additional content items for individual subscribers that are members of the group and/or for individual subscribers with similar preferences with members of the group. Thus, the information in various subscriber profiles and in various subscribers' records stored in the subscriber preference table are used to group subscribers with similar preferences. For instance, a group may include subscribers who indicate in their profiles and/or records that they like romantic comedies. It should be noted that in various embodiments a subscriber can be associated with more than one group, with a score indicating how closely he or she correlates to each group.

Further, in Step 107, records for each one of these groups may be constructed and/or updated that include various categories and scores for each category and stored in a table similar to the subscriber preference table previously described. In various embodiments, the difference between the records in the group reference table and the records in the subscriber reference table is that the scores stored in the records in the group reference table are based on the preference information for all of the subscribers identified for the group.

In addition, in various embodiments, the process 100 further includes obtaining ratings on various programs from subscribers who are included in the group, shown as Step 108. This information is then used to refine the groups (for example, adding or removing subscribers, adjusting the scoring for the group, and periodically recalculating subscriber-to-group correlation scores) and/or the scores stored in the group preference table for the groups, shown as Step 109. As a result, in various embodiments, the provider's system is better able to identify recommendations on content items for individual subscribers based on these groups.

Returning to Step 110, the process 100 continues with identifying one or more groups that correlate with the subscriber. Thus, similar to deriving the groups, in various embodiments, the subscriber's preferences are compared with one or more group's preferences to determine whether the particular subscriber has similar preferences (e.g., a strong enough correlation) and should be included as a member of the group. As a result, in various embodiments, these groups may be used to identify content items to include on the subscriber's playlist. For example, by recommending content that has been rated highly by others in the group, or by recommending content that has high correlation with the group, or with the individual subscriber.

In Step 111, a playlist is generated for the subscriber that provides the titles for content items that the provider has identified that the subscriber may like. In various embodiments, the provider may use the scores in the subscriber preference table, the scores for the affiliated groups in the group preference table, or a combination of both to generate the subscriber's playlist. For instance, as is described in further detail below, the provider may identify one or more content items that the provider has available on its system (such as VOD content) based on the scores stored in the subscribers preference table and/or the scores for affiliated groups stored in group preference table.

For example, in one embodiment, the scores stored for the various categories in the subscriber's record in the subscriber preference table range from zero to one-hundred. In particular, the score for the category “romantic comedies” is twenty and the score for the category “action” is sixty-six. Therefore, in this example, the provider is more likely to identify content items (e.g., television programs and movies) that are categorized as action. In another example, the subscriber's record in the subscriber preference table may include categories based on actors. In this example, the subscriber's record may list the category “Tom Cruise” with a score of fifty-nine and the category “Matt Damon” with a score of eighty-eight. Therefore, the provider is more likely to include titles for content items that star Matt Damon than titles for content items that star Tom Cruise on the subscriber's playlist.

Further, in various embodiments, the provider also makes use of the records in the group preference table to identify content items to include on the subscriber's playlist. As previously discussed, the subscriber may be a member of one or more groups of subscribers with similar preferences. Thus, the provider evaluates the scores stored in the records for these groups in the group preference table to identify content items to include on the subscriber's playlist. In various embodiments, the process 100 may also include a correlation score for each group. This score represents a quantitative measure of correlation between the particular subscriber and the particular group. Therefore, groups with higher correlation scores are given more weight in identifying content items than groups with lower correlation scores.

In Step 112, the playlist is provided to the subscriber. For instance, in one embodiment, the provider's headend system transmits the playlist over the provider's cable network and loads the playlist in the subscriber's VOD service available on the subscriber's set-top box. The subscriber enters into the VOD service and the playlist is provided as an option in the VOD menus. The subscriber selects the playlist and the titles for one or more content items are listed on the playlist for the subscriber to view. The subscriber scrolls through the titles and selects a content item that is of interest to him or her. As a result, the set-top box sends the request through the provider's VOD service to the provider's headend. The headend routes the request to retrieve the particular content item from the appropriate source (e.g., the provider's VOD library) and/or from an external source, such as the Internet. The headend then forwards the content item on a unicast stream to the subscriber's set-top box so that the subscriber may view the content item, shown as Step 113. That is, the headend forwards the content item over a stream intended solely for the subscriber's set-top box. As a result, the subscriber is provided with a playlist that includes content items of particular interest to the subscriber and a personalized channel to view the items from the list.

### System Architecture

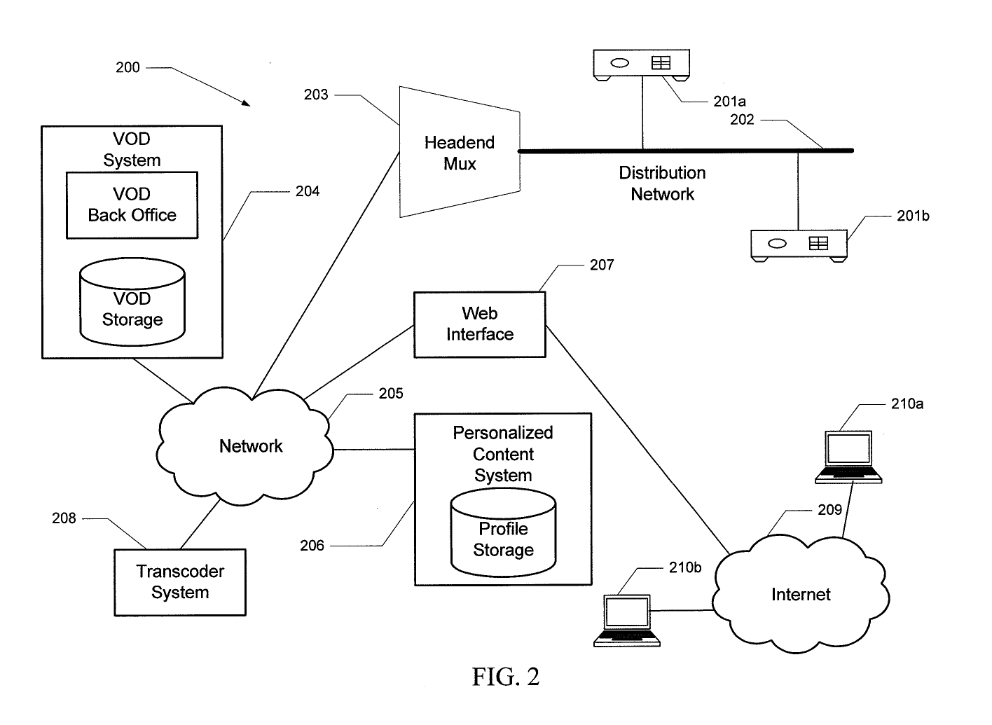

A media content providing system 200 according to various embodiments of the invention is shown in FIG. 2. For instance, the system 200 may be a cable provider's system 200 providing cable programming to the cable provider's subscribers. However, the system 200 may also be a satellite TV provider's system or other wireless providers of video programs. Therefore, the system 200 depicted in FIG. 2 is provided for illustrative purposes only and should not be construed to limit the scope of the claimed invention.

As may be understood from this figure, in various embodiments, the system 200 includes one or more set-top boxes 201a, 201b. In general, these set-top boxes 201a, 201b are devices that are used by subscribers to receive digital cable signals for television and are configured to send data to the headend 203 of the system 200. For example, one of the set-top boxes 201a, 201b may be a device, such as a personal video recorder (PVR) provided by a cable company. The PVR receives the digital cable signal and feeds the signal into an individual's television set so that the individual can view the cable company's cable television programming.

As shown, in various embodiments, the set-top boxes 201a, 201b communicate with the headend 203 of the system 200 over a distribution network 202. The headend 203 routes messages (e.g., subscriber ratings and subscriber requests) received from the set-top boxes 201a, 201b to various components of the provider's system 200 and streams content (e.g., selected content items) to the set-top boxes 201a, 201b. For instance, in one embodiment, the headend 203 receives input from the user via one of the set-top boxes 201a, 201b, interprets the input, and sends the input to the appropriate component of the system 200, such as the VOD system 204 or the personalized content system 206.

In addition, the system 200 of various embodiments may also include a transcoder system 208. This system 208 is configured to perform specific functions within the system 200. For instance, as described in further detail below, the transcoder system 208 may include software and/or hardware components configured to transcode various content into a format that is compatible with the provider's distribution network 202 and corresponding set-top boxes 201a, 201b. Furthermore, several of the components of the system 200 are connected via a network 205 within the system 200 (e.g., a LAN, a wireless network, and/or a private network) and communicate with one another.

As depicted in FIG. 2, the system 200 may also include storage medium, such as VOD storage in the VOD system 204 and profile storage in the personalized content system 206. This storage may also be connected via the network 205 and may communicate with other components of the system 200. In various embodiments, the VOD storage may store the provider's VOD content items and the profile storage may store subscribers' profiles and corresponding preference tables.

Furthermore, in various embodiments, the system 200 may include a Web interface 207 that is in communication with the other components of the system 200. The Web interface 207 may also be in communication with the Internet 209 and may support one or more websites. Various users may access these websites from their personal computers 210a, 210b over the Internet 209. For example, a user may access the websites from a cable modem.

In various embodiments, the components of the system 200 may be one or more devices or may include one or more devices executing software programs. Furthermore, in various embodiments, the storage medium may be one or more types of medium such as hard disks, magnetic tapes, or flash memory.

### Exemplary Personalized Content System

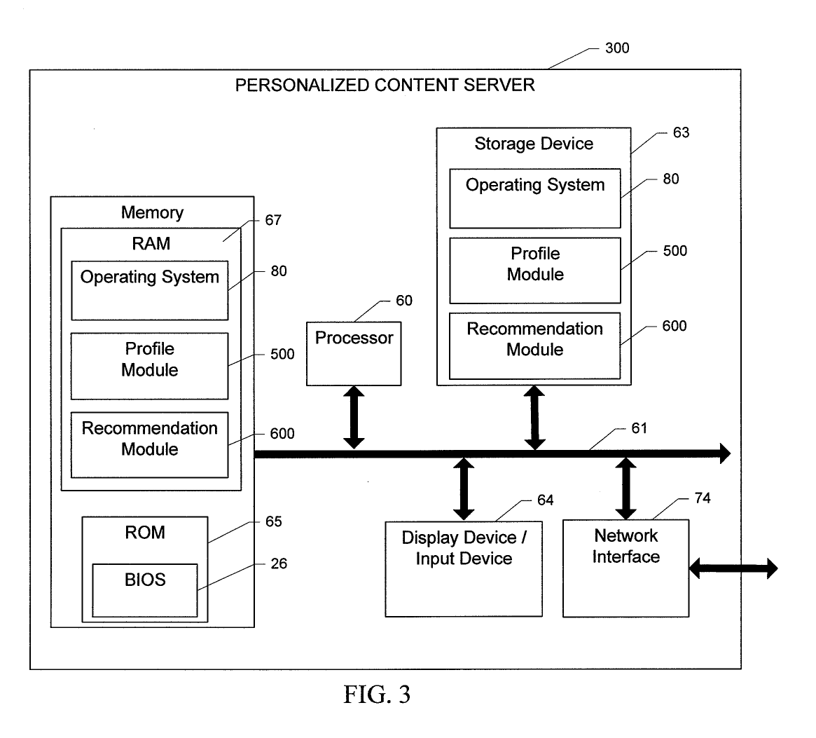

The personalized content system 206 depicted in FIG. 2 may be comprised of several components according to various embodiments. For instance, in one embodiment, the system 206 may comprise one or more servers and a storage medium. In particular, FIG. 3 shows a schematic diagram of a server 300 that may reside in the personalized content system 206 according to one embodiment of the invention. However, it should be understood that the personalized content system 206 does not necessarily need to include only a single server. For instance, in various embodiments, the system 206 may include one or more servers executing one or more software applications. Thus, the server 300 shown in FIG. 3 is provided for illustrative purposes only and should not be construed to limit the scope of the invention.

In FIG. 3, the server 300 includes a processor 60 that communicates with other elements within the server 300 via a system interface or bus 61. Also included in the server 300 is a display device/input device 64 for receiving and displaying data that may be used by administrative personnel. This display device/input device 64 may be, for example, a keyboard or pointing device that is used in combination with a monitor. The server 300 further includes memory 66, which preferably includes both read only memory (ROM) 65 and random access memory (RAM) 67. The server's ROM 65 is used to store a basic input/output system 26 (BIOS), containing the basic routines that help to transfer information between elements within the server 300. Alternatively, the server 300 can operate on one computer or on multiple computers that are networked together.

In addition, the server 300 includes at least one storage device 63, such as a hard disk drive, a floppy disk drive, a CD Rom drive, flash drive, or optical disk drive, for storing information on various computer-readable media, such as a hard disk, a removable magnetic disk, or a CD-ROM disk. As will be appreciated by one of ordinary skill in the art, each of these storage devices 63 is connected to the server bus 61 by an appropriate interface. The storage devices 63 and their associated computer-readable media provide nonvolatile storage for the server 300. It is important to note that the computer-readable media described above could be replaced by any other type of computer-readable media known in the art. Such media include, for example, magnetic cassettes, flash memory cards, digital video disks, and Bernoulli cartridges.

A number of program modules (e.g., set of computer program instructions) may be stored by the various storage devices and within RAM 67. For example, as shown in FIG. 3, program modules of the server 300 may include an operating system 80, a profile module 500, and a recommendation module 600. These modules 500, 600 may be used to control certain aspects of the operation of the server 300, as is described in more detail below, with the assistance of the processor 60 and an operating system 80.

Also located within the server 300 is a network interface 74, for interfacing and communicating with other elements of one or more networks (such as the network 205 described in the media content providing system 200 depicted in FIG. 2.) It will be appreciated by one of ordinary skill in the art that one or more of the server's 300 components may be located geographically remotely from other server 300 components. Furthermore, one or more of the components may be combined, and additional components performing functions described herein may be included in the system 200.

### Exemplary Set-top Box

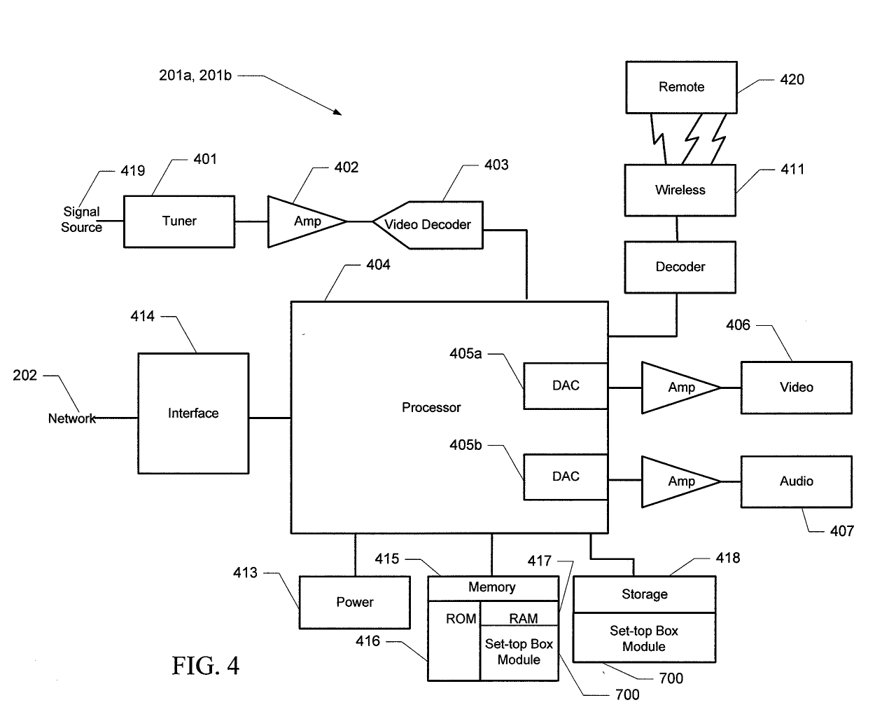

FIG. 4 shows a schematic diagram of a set-top box 201a, 201b according to one embodiment of the invention. The particular set-top box 201a, 201b depicted in FIG. 4 is configured to receive a digital signal from a cable provider or a satellite TV provider and to convert the signal into audiovisual content that is typically displayed on a television.

The particular embodiment of the set-top box 201a, 201b shown in FIG. 4 includes a processor 404 and storage 418, such as a hard disk drive and/or a flash drive, on which audiovisual data may be recorded and stored by the processor 404. In addition, the set-top box 201a, 201b further includes memory 415 composed of both read only memory (ROM) 416 and random access memory (RAM) 417.

The set-top box 201a, 201b further includes a tuner 401 configured to receive the incoming source signal 419. The tuner 401 sends the source signal 419 through an amplifier 402 and a video decoder 403 configured to translate the encoded source signal 419 into its original format. The video decoder 403 directs the translated source signal 419 to the processor 404.

In various embodiments, the processor 404 may also include a digital-to-analog converter (DAC) 405a, 405b configured to convert the translated source signal 419 from a digital signal to an analog signal if the television will only read an analog signal. Furthermore, the processor 404 is configured to feed the translated signal to the video and audio outputs 406, 407 of the set-top box 201a, 201b that are connected to the television.

In addition, the set-top box 201a, 201b may also include a wireless interface 411 that is configured to receive commands (and/or input) from a viewer via transmission from a remote control 420. The remote control 420 may transmit such commands using any number of transmitters, such as a radio frequency transmitter, a supersonic transmitter, or an optical transmitter. Further, the remote control 420 may be configured with cell-phone-spelling style features so that a subscriber may enter text.

A number of program modules (such as a set-top box module 700) may also be stored within the storage 418 and/or within the RAM 217 of the set-top box 201a, 201b. This module 700 may be used to control certain aspects of the operation of the set-top box 201a, 201b, as is described in more detail below, with the assistance of the processor 404.

Also located within the set-top box 201a, 201b is an interface 414, for interfacing and communicating with other elements of a network (such as the headend 203 in communication with the distribution network 202 described in the system 200 depicted in FIG. 2.) It will be appreciated by one of ordinary skill in the art that one or more of the set-top box's 201a, 201b components may be located geographically remotely from other set-top box 201a, 201b components. Furthermore, one or more of the components may be combined, and additional components performing functions described herein may also be included in the set-top box 201a, 201b.

### Exemplary System Operation

In various embodiments, system operation can be considered as two phases. In various embodiments, the first phase of system operation (e.g., profile phase) involves utilizing a profile module 500 so that the system can receive information on a subscriber's preferences with regard to what types of media the subscriber likes. This profile module 500 may reside on the personalized content system 206 (e.g., personalized content server 300) and/or the subscriber's set-top box 201a, 201b. The second phase of system operation involves providing the subscriber with his or her playlist that includes titles for one or more content items and providing a personalized channel to the subscriber for viewing content items from the playlist (e.g., viewing phase). For instance, in various embodiments, the personalized content system 206 also includes a recommendation module 600 that is adapted to provide the subscriber with the playlist based on the subscriber's preferences. Furthermore, in various embodiments, the set-top box 201a, 201b may include a module 700. In these particular embodiments, this module 700 is adapted to perform one or more tasks such as facilitate the displaying of the subscriber's personal playlist on the subscriber's television, allow the subscriber to select a particular content item from his or her playlist to view, and facilitate the displaying of the content item on the subscriber's television for viewing. These modules 500, 600, 700 are described in more detail below.

### Profile Module

As previously discussed, in various embodiments, the personalized content system 206 and/or subscriber's set-top box 201a, 201b may include a profile module 500 that is adapted to provide the tools necessary to allow a subscriber to configure a profile for the subscriber that includes information on the subscriber's preferences for media content. The subscriber may access these tools (e.g., the module 500) in various ways according to embodiments. For instance, in one embodiment, the subscriber accesses the module 500 through the subscriber's set-top box 201a, 201b. Thus, for example, the subscriber may call up an application on the subscriber's television that resides in the VOD service on the subscriber's set-top box 201a, 201b or that resides in a stand-along service. That is, the subscriber may select a button on his or her remote control that signals to the subscriber's set-top box 201a, 201b to display the VOD service on the subscriber's television. In another embodiment, the subscriber may access the profile module 500 through one or more Web pages. For example, the personalized content system 206 may be in communication with a Web interface 208 that provides a website on the Internet 210 (as shown in the system 200 depicted in FIG. 2). Thus, the subscriber visits the website over the Internet 210 and configures the subscriber's profile by accessing the profile module 500 through the website.

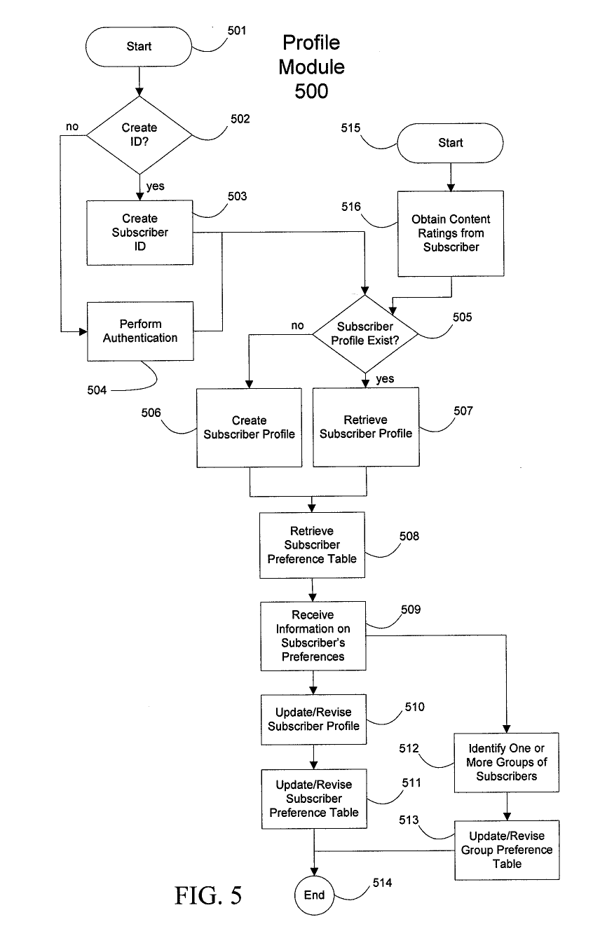

Accordingly, FIG. 5 illustrates a flow diagram of a profile module 500 according to various embodiments. This flow diagram may correspond to the steps carried out by the processor 60 in the personalized content server 300 shown in FIG. 3 or the processor 404 in the set-top box 201a, 201b shown in FIG. 4 as it executes the module 500 in the server's or set-top box's RAM memory 67, 417 according to various embodiments.

The subscriber enters into the profile tool and the profile module 500 determines whether to create a user identifier for the subscriber, shown as Step 502. In various embodiments, the subscriber may be provided with an initial login screen. For instance, in one embodiment, the screen requests the subscriber's username, password, and/or account number or provides an option for the subscriber to create a username and password. Therefore, the subscriber may select the option to create a username and password and enters a username and password (along with other relevant information such as account number) on a subsequent screen. In response, the profile module 500 verifies the username and password are valid (e.g., verifies that the username and/or password are unique) and creates the user identifier, shown as Step 503. In other embodiments, such as for example, when the profile module 500 resides on the subscriber's set-top box 201a, 201b and/or the profile is stored locally on the set-top box 201a, 201b, the subscriber may simply indicate on the initial screen to create a user identifier.

In various embodiments, the user identifier uniquely identifies the particular subscriber and can be used to retrieve the subscriber's profile and related information and allow the subscriber to manage his or her profile. Once the module 500 has created the identifier, the module 500 saves the identifier in some storage medium, such as the profile storage shown in the personalized content system 206 depicted in FIG. 2 or storage on the set-top box 201a, 201b.

If the profile module 500 determines that a user identifier does not need to be created, in various embodiments, the module 500 in various embodiments performs an authentication process for the particular subscriber, shown as Step 504. For instance, in one embodiment, the module 500 reads the subscriber's username, password, and/or account number and confirms the username and password match (that is, the module 500 confirms the subscriber has entered the correct password for the entered username).

Once the profile module 500 authenticates the subscriber's username and password, the module 500 determines whether a profile (e.g., profile data) exists for the subscriber, shown as Step 505. For instance, in one embodiment, the profile is stored in a database or in one or more files in the profile storage in the provider's system 200 or stored in one or more files locally on the set-top box 201b, 201b. In the embodiments in which the profiles are stored in the provider's system 200, the profile module 500 queries the profile storage (using the subscriber's unique identifier, for example) to determine whether a profile exists for the particular subscriber. If the module 500 determines a profile does exist for the subscriber, the module 500 retrieves the profile, shown as Step 507. If the module 500 determines a profile does not exist for the subscriber, the module 500 creates a profile for the subscriber, shown as Step 506. According to various embodiments, the profile is stored as or in one or more tables in a database or as one or more data files in the profile storage.

In addition, in various embodiments, the profile module 500 retrieves a subscriber preference table, shown as Steps 508. As will be described in greater detail below, this preference table is used as a tool for identifying what content items to include on the subscriber's playlist. Similar to the profile, this table may be stored in a database or in one or more data files in the profile storage.

In various embodiments, the profile module 500 provides the subscriber with a first screen that requests the subscriber to provide basic information about the subscriber such as the subscriber's residential address and/or what possible cable distribution area the subscriber is associated with. In some embodiments, this information may be retrieved automatically based on other information such as the subscriber's account number for the provider. In addition, in various embodiments, the profile module 500 presents the subscriber with one or more questions that help to define the subscriber's preferences with respect to media content, shown as Step 509. For instance, in one embodiment, the profile module 500 may present the subscriber with a group of screens that request the subscriber's input on a list of questions. For example, the profile module 500 may asked the subscriber to answer such questions as “How much do you like action movies?” A rating (for example, one to ten) can be provided by the subscriber for each question that indicates how positively the subscriber feels about the question. These questions can be broad, narrow, or a combination of both depending on the embodiment. Therefore, the profile module 500 may ask questions such as “How much do you like the actor Johnny Depp?” or “How much do you like Steven Spielberg's movies?” Further, the profile module 500 may ask questions that are more involved such as “Please list your five favorite actors and provide a rating for each actor.” or “Please list your five favorite movies and provide a rating for each movie.”

Furthermore, in various embodiments, the profile module 500 is also adapted to receive information on subscribers' viewing habits and content ratings from these subscribers. For instance, the profile module 500 in various embodiments obtains content ratings from the subscriber based on a content item the subscriber has viewed. (This is an alternative way of initiating the profile module 500, shown as Step 515 in FIG. 5.) At the conclusion of a television program and/or movie (or at the time the subscriber stops watching television program and/or movie), the subscriber is presented with one or more screens that ask the subscriber for input on the viewed content. For example, the subscriber may simply be asked to rate the program he or she has just watched. In other embodiments, the subscriber may be asked a series of questions on the content that provide more detail on what the subscriber liked and disliked about the content. For example, the subscriber may be asked questions with regard to the actors who appeared in the program or movie. In various embodiments, the subscriber may be encouraged to answer the questions because such information will improve the ability for the provider to identify further content the subscriber will like.

In response, the profile module 500 receives the ratings from the subscriber, shown as Step 516. For instance, in one embodiment, the subscriber enters the ratings using his or her remote control and the ratings are forwarded by the subscriber's set-top box 201a, 201b over the provider's distribution network 202 and back to the profile module 500. While in another embodiment, the profile module 500 is located directly on the subscriber's set-top box 201a, 201b and obtains the ratings directly from the subscriber. At this point, the profile module 500 determines whether a profile exists for the subscriber and creates or retrieves the profile in a similar fashion as previously described (Steps 505, 506, and 507). It should be appreciated by one of ordinary skill in the art that the profile module 500 in various embodiments can be configured to gather viewing habit and rating information without receiving any initial profile information from the subscriber. However, such initial profile information may be helpful in accelerating the process of classifying the subscriber.

Once the profile module 500 has received the information on the subscriber's preference, the profile module 500 updates/revises the subscriber's profile, shown as Step 510. Therefore, the module 500 updates/revises the subscriber's profile to reflect the information received from the subscriber. The profile module 500 then saves the updated/revised profile. In a similar fashion, in various embodiments, the profile module 500 also updates/revises the subscriber preference table to reflect the information received from the subscriber and saves the updated/revised preference table in the profile storage, shown as Step 511.

The subscriber preference table may be configured in numerous ways according to various embodiments. For instance, in one embodiment, the subscriber preference table includes one or more categories along with a score for each category. This score reflects the subscriber's preference for media content that is related to the particular category. For example, in one embodiment, the subscriber preference table is made up of columns for each category and a row for each subscriber that includes a score for each combination of category and subscriber, such as:

### EXAMPLE OF SUBSCRIBER PREFERENCE TABLE

| | | Action- | | | | |
|---|---|---|---|---|---|---|
| | Comedy | Adventure | Drama | News | Actor 1 | Etc . . . |
| Subscriber 1 | 45 | 30 | 10 | 60 | 0 | |
| Subscriber 2 | 75 | 90 | 40 | 10 | 50 | |
| Subscriber 3 | 10 | 30 | 60 | 10 | 90 | |
| . . . | | | | | | |

As previously mentioned, the categories may include several different classifications according to various embodiments, such as types of movies, specific movies, television shows, musical genres, and topics (e.g., wars, history, football, science). As mentioned above, these scores are revised based on preference information received from the subscriber (e.g., at Step 511). For instance, the profile module 500 updates/revises the record for the particular subscriber in the subscriber preference table based on the ratings received from the subscriber (e.g., at Step 509).

In the example provided above, the scores for each category are based on a one-hundred point scale and the initial score for a category is fifty for a category the subscriber indicates he or she likes and zero for the other categories. (However, other rating schemes may be used in various embodiments.) Subscriber 1 views a comedy and provides a rating of five for the comedy that indicates how much he or she liked the comedy. (In this example, the rating scale is from one to ten with ten being the highest rating.) In addition, Subscriber 2 views a comedy and provides a rating of four for the comedy. (It should be noted that in various embodiments any one content item may be placed into one or more categories. For instance, the movie “Blazing Saddles” may be placed in the categories of comedy and western.)

In this particular example, the subscriber preference table may be updated as follows:
For each individual content item score S, K is calculated as K=S−5. Therefore, for ratings less than 5, K is negative and will reduce the overall score in the table. The overall score is calculated as TS=IS+[sum(K)/(5*N)]*50, wherein IS is the subscriber's initial score and N is the number of individual content items that have been rated. Subscriber 1 has watched nine previous movies in this category and provided the following ratings: 4, 7, 8, 5, 7, 6, 6, 7, 9. In addition, Subscriber 2 has watched nine previous movies in this category and provided the following ratings: 5, 4, 6, 6, 7, 7, 3, 2, 5. Thus, the results are:

| | Initial Score | Rating | Sum(K) | N | Revised Score |
|---|---|---|---|---|---|
| Subscriber 1 | 50 | 5 | 14 | 10 | 64 |
| Subscriber 2 | 0 | 4 | −3 | 10 | −3 (remains 0) |

Therefore, the subscriber table is revised so that the score for Subscriber 1 under the comedy category is updated to sixty-four and the score for Subscriber 2 under the comedy category remains zero.

Alternately, the algorithm used for revising the score can be designed to de-emphasize the initial rating over time, as ratings for viewed content items are accumulated. Similar to the previous example, the initial score for a category is fifty for a category the subscriber indicates he or she likes and zero for the other categories. As more ratings are accumulated for individual content items viewed by the subscriber, the initial score is diminished. Thus, the algorithm is:

TS=IS+{100−[IS/(N+1)]}*[sum(S)/(10*N)]

### Where:

TS=the total score for a category

IS=the initial score based on the subscriber's self rating

N=the number of movies the subscriber has rated

S=the score (on a 1 to 10 scale) given to an individual content item corresponding to the category (i.e., a movie with the actor corresponding to the category; a movie for the genre corresponding to the category; etc.). Therefore, from the example above the results are:

| | Initial Score | Revised Score |
|---|---|---|
| Subscriber 1 | 50 | 63.36 |
| Subscriber 2 | 0 | −3 (remains 0) |

It should be apparent to one on ordinary skill that any number of algorithms can be used for revising the scores for a subscriber and/or group in light of this disclosure.

In various embodiments, the profile module 500 is also configured to compare the preference data for various subscribers to identify groups of subscribers with similar preferences. The module 500 may consider all of the provider's subscribers or a subset of the provider's subscribers. For instance, in one embodiment, the profile module 500 reviews the information in all of the available profiles for the provider's subscribers and groups the subscribers together whose profile information indicates that they like romantic comedies. Further, the profile module 500 may be configured to derive these groups on any level of granularity depending on the embodiment. For example, in one embodiment, the profile module 500 is configured to derive a group of subscribers whose preference information indicates that they like action movies and the actors Bruce Willis, Keanu Reeves, and Arnold Schwartzenegger.

In addition, in various embodiments, the profile module 500 is configured to generate a group preference table for these groups similar to the subscriber preference table previously described. For instance, in one embodiment, the group preference table includes a column for each category and a row for each group along with a score for each combination of category and group, such as:

### EXAMPLE OF GROUP PREFERENCE TABLE

| | | Action- | | | | |
|---|---|---|---|---|---|---|
| | Comedy | Adventure | Drama | News | Actor 1 | Etc . . . |
| Group 1 | 41.3 | 33.2 | 11.9 | 61.4 | 5 | |
| Group 2 | 78.3 | 87.2 | 38.2 | 11.0 | 51.8 | |
| Group 3 | 14.3 | 22.1 | 57.0 | 13.8 | 87.1 | |
| . . . | | | | | | |

Similar to the subscriber preference table, the categories in the group preference table may include several different classifications according to various embodiments. In addition, in one embodiment, the score for each category is derived as an average of the scores of the subscribers included in the group (e.g., members of the group) for the particular category. Further, the scores in the group preference table are revised based on additional preference information received from members of the group.

Thus, in various embodiments, in response to receiving information from the subscriber on his or her preferences, the profile module 500 identifies one or more groups whose preferences strongly correlate with the subscriber's preferences, shown as Step 512. In particular embodiments, this may entail the profile module 500 determining the level of correlation the subscriber has to each group based on the preferences of the subscriber and the preferences of the group. In various embodiments, the level of correlation may be represented with a correlation score that indicates how strongly the subscriber's preferences match the preferences of the group. In these particular embodiments, the profile module 500 may determine whether the correlation score is above a predetermined threshold in order to include the subscriber in the particular group. Therefore, the profile module 500 of various embodiments determines whether previously identified groups' preferences still strongly correlate with the subscriber's preferences and/or identifies new groups with whom the subscriber's preferences strongly correlate. Thus, in various embodiments, as the profile module 500 receives additional information over time from the subscriber, the module 500 is able to refine the groups for which the subscriber is made a member. For instance, in one embodiment, the algorithm which generates the scores in these tables is rerun periodically to adjust the scores based on recent movies rated by various subscribers. Alternatively, the individual ratings and correlation to groups can be rerun each time the viewer rates a movie.

Accordingly, in various embodiments, the profile module 500 updates/revises the group preference table based on the information received from the subscriber, shown as Step 513. Thus, the profile module 500 may revise one or more scores for one or more groups for which the subscriber is a member based on the information received from the subscriber. For example, the profile module 500 may update/revise the group preference table based on the same approaches as described above with regard to the subscriber preference table.

### Recommendation Module

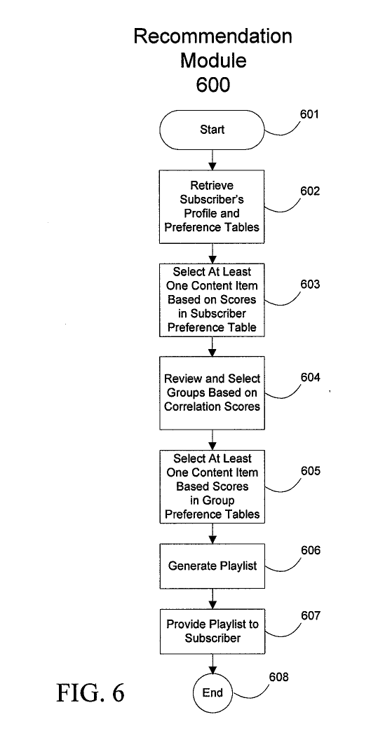

In various embodiments, the personalized content system 206 may also include a recommendation module 600 that is configured to provide a subscriber with the subscriber's personalized playlist. In various embodiments, the personalized content system 206 is located at a central location within the provider's system (for example, as shown in FIG. 2) and is in communication over the provider's cable distribution network 202 from the subscriber's set-top box 201a, 201b. However, in other embodiments, the system 206 is located locally on the subscriber's set-top box 201a, 201b. Accordingly, FIG. 6 illustrates a flow diagram of the recommendation module 600 according to various embodiments. This flow diagram may correspond to the steps carried out by the processor 60 in the personalized content server 300 shown in FIG. 3 as it executes the module 600 in the server's RAM memory 67 according to various embodiments.

In particular embodiments, the provider's system 200 is configured to periodically download a program guide to the subscriber's set-top box 201a, 201b. The program guide provides information on what programming is available to the subscriber via the provider. For instance, the program guide provides a listing of what programming is broadcast to all subscribers and associated information about the programming such as the channel, date, and time the programming will be streamed on the channel. Further, in various instances, the program guide also provides a listing of what programming is available through the provider's VOD service. Thus, the program guide is used by the set-top box 201a, 201b to provide a listing of what programming and movies are available through VOD when a subscriber calls up the VOD service on his or her set-top box 201a, 201b.

In various embodiments, the provider's system 200 is configured to call the recommendation module 600 to provide a playlist to incorporate into a new program guide for a particular subscriber when the system 200 downloads the new program guide to the subscriber's set-top box 201a, 201b. For instance, in one embodiment, the provider's system 200 calls the recommendation module 600 and provides the subscriber's identifier. In other embodiments, the provider's system 200 is configured to call the recommendation module 600 at a preset time based on a schedule. In response, the recommendation module 600 retrieves the subscriber's profile, the subscriber preference table, and the group preference table, shown as Step 602. Thus, in one embodiment, the recommendation module 600 queries the subscriber's profile and the preference tables from the profile storage. In another embodiment, the recommendation module 600 retrieves the subscriber's profile and/or the preference tables from the subscriber's set-top box 201a, 201b. Still, in another embodiment, the recommendation module 600 retrieves the subscriber's profile and the preference tables from both the profile storage and the subscriber's set-top box 201a, 201b.

In various embodiments, the recommendation module 600 identifies one or more content items to include on the subscriber's playlist based on the subscriber's preferences. That is, in Step 603, the recommendation module 600 selects one or more content items based on the subscriber's scores found in the subscriber preference table. This identification process can take many forms according to various embodiments.

For instance, in one embodiment, each content item is scored against the categories based on user ratings. For example, a variety of subscribers with various tastes view and rate a content item, such as a movie. The movie is then given a score in each category based on a combination of the rating given by each subscriber and the individual subscriber's score for the particular category. This process may be carried out by any number of components of the provider's system 200. For instance, the profile module 500 may be configured to perform this function and to store the content item's scores for each category. As a result, once enough subscribers have rated the content item, the content item has ratings for each column.

Thus, the recommendation module 600 measures the correlation between the content item's scores and the subscriber's scores as a predictor of how well the subscriber will like the content item. This measurement process can be carried out in a variety of different ways according to various embodiments. For example, in one embodiment, the recommendation module 600 may use the Pearson product-moment correlation coefficient as a measure of the correlation between the content item's scores and the subscriber's scores. The recommendation module 600 compares the correlation coefficient with a threshold value to determine whether to include the content item on the subscriber's playlist. For instance, in the example, the correlation coefficient must exceed 0.5 in order to add the content item to the subscriber's playlist.

In addition, in various embodiments, the recommendation module 600 is further configured to consider other factors in determining whether to include a content item on the subscriber's playlist. For instance, the recommendation module 600 may look at such factors as whether the content item has been placed on the subscriber's playlist previously, whether the content item has been previously viewed by the subscriber, and whether the subscriber has specifically indicated that he or she is not interested in the content item.

In addition to the recommendation module 600 identifying content items based on the subscriber preference table, in various embodiments, the recommendation module 600 also identifies content items based on the scores in the group preference table. In particular embodiments, the recommendation module 600 identifies what particular groups the subscriber has a strong correlation with. For instance, in one embodiment, the recommendation module 600 compares the correlation values for each group saved in the subscriber's profile. Thus, the recommendation module 600 may be configured to review and select a number of groups based on the correlation values, shown as Step 604. For example, the recommendation module 600 may be configured to select the five groups with the highest correlation values. In other embodiments, the recommendation module 600 may be configured to consider other factors such as whether the subscriber is a member of the group.

In Step 605, the recommendation module 600 identifies one or more content items based on the scores in the group preference table for the identified groups. This process may be carried out in a similar fashion as the process described above with regard to the subscriber preference table. In other embodiments, this process may be carried differently than the process used with regard to the subscriber preference table. For instance, in one embodiment, the recommendation module 600 may simply place a movie on a recommendation list for other members of a group once a certain number of members of a given group have rated a given content item highly.

In Step 606, the recommendation module 600 generates the playlist for the subscriber. In particular embodiments, this entails the recommendation module 600 constructing a list of the titles of the identified content items. Further, the recommendation module 600 may also include additional information on each content item such the year the content item was released, a brief description of the content item, and the artists associated with the content item. In addition, the recommendation module 600 may sort the content items in the playlist according to the degree of correlation between the subscriber's preference scores and the item's metadata and/or scores, so that the titles for content items most likely to be preferred are listed first.

In addition, in various embodiments, the recommendation module 600 may also include one or more advertisements along with the playlist. The recommendation module 600 may select these advertisements based on various factors, such as information in the subscriber's profile, the scores stored in the subscriber preference table for the subscriber, the scores stored in the group preference table for groups whose preferences strongly correlate with the subscriber, and the content item titles on the subscriber's playlist. As a result of using such information in various embodiments, the provider is able to identify advertisements that better target the subscriber. Further, in various embodiments, a subscriber's responsiveness to advertisements is measured. For instance, subscribers are given an option to rate advertisements and/or products etc. As a result, in these embodiments, subscriber and group responsiveness to particular advertisements can be used to further target advertising.

In Step 607, the recommendation module 600 provides the subscriber with the playlist of titles. As previously discussed, in one embodiment, the recommendation module 600 provides the playlist so that the playlist is included in the program guide downloaded to the subscriber's set-top box 201a, 201b. However, in another embodiment, the recommendation module 600 provides the playlist to the subscriber through a separate communication capability interacting with the subscriber's set-top box 201a, 201b.

In turn, the subscriber reviews the playlist and titles (and associated information) and selects a particular content item to view. For instance, in one embodiment, the subscriber invokes the provider's VOD service and the playlist is provided as a menu option in the VOD service. In another embodiment, the subscriber invokes an entirely separate application that resides on the subscriber's set-top box 201a, 201b to view the playlist.

As a result, in various embodiments, the subscriber's set-top box 201a, 201b sends the subscriber's selection over the provider's distribution network 202 and back to the headend 203. The headend 203 directs the request to the appropriate component of the provider's system 200 and the component fulfills the subscriber's request. For example, in one embodiment, the headend 203 directs the request to the VOD system 204. In response, the VOD system 204 retrieves the content item and transmits the content item to the subscriber's set-top box 201a, 201b. Therefore, in the system 200 depicted in FIG. 2, the VOD system 204 transmits data packets associated with the content item through the provider's headend 203, over the provider's cable distribution network 202, to the subscriber's set-top box 201a, 201b. In many instances, the data packets are transmitted over a unicast stream to the subscriber's set-top box 201a, 201b similar to VOD content. Thus, the headend 203 sends data to the set-top box 201a, 201b to instruct the set-top box 201a, 201b to tune to a channel carrying the stream comprising the data packets and transmits the data packets over the stream to the subscriber's set-top box 201a, 201b.

It should be appreciated that the content items may come from several sources in various embodiments. For instance, one source of the content items may be the content items that are available through the provider. For example, one source for the content items is the programming and movies that are available through the provider's broadcast programming and VOD services. However, various embodiments may also incorporate additional sources. For example, in particular embodiments, the provider system 200 may also review sources that are available over the Internet. These sources may include content downloaded to various web sites such as YouTube® and/or may include additional content associated with other content items. For instance, a provider may broadcast a news television program that shows a story on the Amazon rain forest and the subscriber may rate the television program as high. As a result, the recommendation module 600 may look at content items available over the Internet related to the Amazon rain forest as possible content items to include on the subscriber's playlist.

A great deal of this content may not be in a suitable format compatible with the provider's distribution network 202. As a result, in various embodiments, the provider's system may also include a transcoder system 208 that is configured to re-format such content into a format that is compatible with the provider's distribution network 202, such as, for example, MPEG.

### Set-Top Box Module

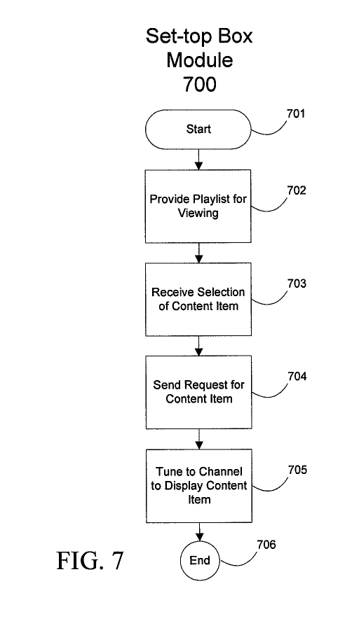

In various embodiments, the user's set-top box 201a, 201b may include a set-top box module 700 that is configured to provide the subscriber with the subscriber's personalized playlist of content items, to receive a request from the subscriber for a particular content item on the playlist, and to facilitate the viewing of the particular content item for the subscriber. As previously described, the subscriber's personal playlist may be provided in the program guide that is downloaded to the subscriber's set-top box 201a, 201b in various embodiments. Further, the set-top box module 700 in various embodiments may simply be the module (or an extension of the module) that provides the subscriber with VOD service or may be a stand-alone module in other embodiments. For illustrative purposes only, the set-top box module 700 is described as the module that provides the subscriber with VOD service. However, this description should not be construed as limiting the scope of the claimed invention. Accordingly, FIG. 7 illustrates a flow diagram of a set-top box module 700 according to various embodiments. This flow diagram may correspond to the steps carried out by the processor 304 in the set-top box 201a, 201b shown in FIG. 4 as it executes the module 700 in the box's RAM memory 417.

In various embodiments, the subscriber may desire to view his or her personal playlist and may request to bring up the VOD service on the viewer's television screen. In response, in Step 702, the set-top box module 700 provides one or more screens (e.g., menus) that include the playlist that the viewer may used to navigate the playlist. For example, in one embodiment, the set-top box module 700 reads programming information from the program guide that resides on the subscriber's set-top box 201a, 201b and the program guide includes information on the subscriber's playlist. The set-top box module 700 reads this information and provides the playlist as an option on one or more of the menus provided in the VOD service. The viewer peruses the titles on the playlist and selects a particular content item (e.g., video program or movie) for viewing. For instance, the viewer may use his or her remote control to navigate through the various menus of the VOD service to the playlist and select a particular content item by pressing one or more buttons on the remote control.

In Step 703, the set-top box module 700 receives the subscriber's request for the particular content item. In various embodiments, the module 700 sends the subscriber's request over the provider's distribution network 202 to the head-end 203 of the provider's system, shown as Steps 704. In various embodiments, the head-end 203 routes the request to the appropriate component of the provider's system 200 (e.g., to the VOD system 204), and the component retrieves the particular content item from storage. For example, the VOD system 204 retrieves a video file from the VOD storage for the particular content item. The component then routes the content item to the subscriber's set-top box 201a, 201b. For instance, in one embodiment, the component forwards the content item (e.g., video file) to the headend 203 and the headend 203 transmits the content item to the subscriber's set-top box 201a, 201b over a unicast stream (e.g., similar to a VOD selection).

In response, the set-top box module 700 tunes to the channel that corresponds to the unicast stream and the module 700 displays the content item for the subscriber's viewing on the channel, shown as Step 705. As a result, in various embodiments, the subscriber is provided with a personalized playlist of content items that has been constructed based on the subscriber's preferences and the preferences of groups who have correlating tastes. Further, the subscriber is provided with a personalized channel to view content from the playlist.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

What is claimed is:

1. A system for selecting content for a subscriber of a video service provider comprising:
a computer system adapted to:
(a) generate a subscriber profile comprising information on the subscriber's viewing preferences received from the subscriber:
(b) store the subscriber profile in memory;
(c) generate a first record in a subscriber preference table for the subscriber based on the subscriber profile, the first record comprising one or more categories of content and a first score for each category of the one or more categories of content;
(d) identify one or more groups of subscribers whose viewing preferences correlate with the subscriber's viewing preferences based on a correlation threshold, each group of the one or more groups is associated with a second record in a group preference table, the second record comprising the one or more categories of content and a second score for each category of the one or more categories of content;
(e) select at least a first content item from available content items stored in the memory based on the first scores associated with the first record in the subscriber preference table;
(f) select at least a second content item from the available content items stored in the memory based on the second scores associated with the second records in the group preference table;
(g) generate a playlist for the subscriber comprising titles for at least the first content item and the second content item; and
(h) in response to receiving a rating from the subscriber for a content item viewed by the subscriber, revise a first score associated with the first record for at least one category of the one or more categories of content in the subscriber preference table based on the rating.

2. The system of claim 1 comprising:
a headend adapted to:
(a) transmit the playlist to a subscriber's set-top box, wherein the subscriber's set-top box displays the playlist that comprises the titles for at least the first content item and the second content item to the subscriber; and
(b) in response to the subscriber selecting the title for the first content item or the second content item from the playlist, transmit the first content item or the second content item over a unicast stream to the subscriber's set-top box, wherein the subscriber's set-top box tunes to the unicast stream to display the first content item or the second content item.

3. The system of claim 2, wherein the headend transmits the playlist and the content item over a cable provider's network to the subscriber's set-top box.

4. The system of claim 1, wherein the system is adapted to:
provide a profile interface, and the system receives the information on the subscriber's viewing preferences from the subscriber accessing the profile interface.

5. The system of claim 4, wherein the profile interface is adapted to be accessed by the subscriber over a web site.

6. The system of claim 1, wherein a profile interface is provided on a subscriber's set-top box and the profile interface is adapted to receive the information on the subscriber's viewing preferences by the subscriber accessing the profile interface through a VOD service residing on the subscriber's set-top box.

7. The system of claim 1, wherein the information on the subscriber's viewing preferences is based on historical program selection data of the subscriber.

8. The system of claim 1, wherein the system is adapted to:
assign a correlation score to each identified group of the one or more groups, the correlation score represents a quantitative measure of correlation the subscriber's viewing preferences has with the particular identified group's viewing preferences; and
select at least the second content item from the available content items stored in the memory based on the second scores associated with the second records in the group preference table and the correlation score for each group of the identified groups.

9. The system of claim 1, wherein the computer system is adapted to revise one or more second scores associated with the second records for at least one category of the one or more categories of content in the group preference table based on the rating in response to receiving the rating from the subscriber for the content item viewed by the subscriber.

10. The system of claim 1, wherein the computer system is adapted to:
select at least a third content item from accessing available content items stored external from the cable provider based on the scores associated with the first record in the subscriber preference table; and
select at least a fourth content item from accessing the available content items stored external from the cable provider based on the scores associated with the second records in the group preference table, wherein the playlist for the subscriber further comprises titles for the third content item and the fourth content item.

11. The system of claim 1, wherein the playlist is displayed using a video-on-demand (VOD) service.

12. The system of claim 1, wherein the system is adapted to:
include one or more advertisements with the playlist based on the subscriber profile, wherein the advertisements are displayed along with the playlist.

13. The system of claim 12, wherein the one or more advertisements are also based on at least one identified group of the one or more groups.

14. A method for selecting content for a subscriber of a video service provider, the method comprising the steps of:
(a) generating with a computer device a subscriber profile comprising information on the subscriber's viewing preferences received from the subscriber:
(b) storing the subscriber profile in memory;
(c) generating a first record in a subscriber preference table for the subscriber based on the subscriber profile, the first record comprising one or more categories of content and a first score for each category of the one or more categories of content;
(d) identifying one or more groups of subscribers whose viewing preferences correlate with the subscriber's viewing preferences based on a correlation threshold, each group of the one or more groups is associated with a second record in a group preference table, the second record comprising the one or more categories of content and a second score for each category of the one or more categories of content;
(e) selecting with the computer device at least a first content item from available content items stored in the memory based on the first scores associated with the first record in the subscriber preference table;
(f) selecting with the computer device at least a second content item from the available content items stored in the memory based on the second scores associated with the second records in the group preference table;
(g) generating with the computer device a playlist for the subscriber comprising titles for at least the first content item and the second content item; and
(h) in response to receiving a rating from the subscriber for a content item viewed by the subscriber, revising the first score associated with the first record for at least one category of the one or more categories of content in the subscriber preference table based on the rating.

15. The method of claim 14 further comprising the step of:
(i) transmitting the playlist to a subscriber's set-top box, wherein the subscriber's set-top box displays the playlist that comprises the titles for at least the first content item and the second content item to the subscriber; and
(j) in response to the subscriber selecting the title for the first content item or the second content item from the playlist, transmitting the first content item or the second content item over a unicast stream to the subscriber's set-top box, wherein the subscriber's set-top box tunes to the unicast stream to display the first content item or the second content item.

16. The method of claim 15, wherein the step of transmitting the playlist and the content item is performed over a cable provider's network to the subscriber's set-top box.

17. The method of claim 14 further comprising the step of:
providing a profile interface on the computer device, wherein the information on the subscriber's viewing preferences is received from the subscriber accessing the profile interface.

18. The method of claim 17, wherein the subscriber accesses the profile interface over a web site.

19. The method of claim 14 further comprising the step of:
providing a profile interface on a subscriber's set-top box, wherein the information on the subscriber's viewing preferences is received from the subscriber accessing the profile interface through a VOD service residing on the subscriber's set-top box.

20. The method of claim 14, wherein the information on the subscriber's viewing preferences is based on historical program selection data of the subscriber.

21. The method of claim 14 further comprising the steps of:
assigning with the computer device a correlation score to each identified group of the one or more groups, the correlation score represents a quantitative measure of correlation the subscriber's viewing preferences has with the particular identified group's viewing preferences; and
selecting with the computer device at least the second content item from the available content items stored in the memory based on the second scores associated with the second records in the group preference table and the correlation score for each group of the identified groups.

22. The method of claim 14 further comprising the step of:
in response to receiving the rating from the subscriber for the content item viewed by the subscriber, revising one or more second scores associated with the second records for at least one category of the one or more categories of content in the group preference table based on the rating.

23. The method of claim 14 further comprising the steps of:
selecting with the computer device at least a third content item from accessing available content items stored external from the cable provider based on the scores associated with the first record in the subscriber preference table; and
selecting with the computer device at least a fourth content item from accessing the available content items stored external from the cable provider based on the scores associated with the second records in the group preference table, wherein the playlist for the subscriber further comprises titles for the third content item and the fourth content item.

24. The method of claim 14, wherein the playlist is displayed using a VOD service.

25. The method of claim 14 further comprising the step of:
including one or more advertisements with the playlist based on the subscriber profile, wherein the advertisements are displayed along with the playlist.

26. The method of claim 25, wherein the one or more advertisements are also based on at least one identified groups of the one or more groups.

27. A computer-readable medium containing code executable by a processor for selecting content for a subscriber of a video service provider comprising computer-readable program instructions adapted for:
(a) generating a subscriber profile comprising information on the subscriber's viewing preferences received from the subscriber:
(b) storing the subscriber profile in memory;
(c) generating a first record in a subscriber preference table for the subscriber based on the subscriber profile, the first record comprising one or more categories of content and a first score for each category of the one or more categories of content;
(d) identifying one or more groups of subscribers whose viewing preferences correlate with the subscriber's viewing preferences based on a correlation threshold, each group of the one or more groups is associated with a second record in a group preference table, the second record comprising the one or more categories of content and a second score for each category of the one or more categories of content;
(e) selecting at least a first content item from available content items stored in the memory based on the first scores associated with the first record in the subscriber preference table;
(f) selecting at least a second content item from the available content items stored in the memory based on the second scores associated with the second records in the group preference table;
(g) generating a playlist for the subscriber comprising titles for at least the first content item and the second content item; and
(h) in response to receiving a rating from the subscriber for a content item viewed by the subscriber, revising the first score associated with the first record for at least one category of the one or more categories of content in the subscriber preference table based on the rating.

28. The computer-readable medium of claim 27 further comprising computer-readable program instructions adapted for:
(i) transmitting the playlist to a subscriber's set-top box, wherein the subscriber's set-top box displays the playlist that comprises the titles for at least the first content item and the second content item to the subscriber; and
(j) in response to the subscriber selecting the title for the first content item or the second content item from the playlist, transmitting the first content item or the second content item over a unicast stream to the subscriber's set-top box, wherein the subscriber's set-top box tunes to the unicast stream to display the first content item or the second content item.

29. The computer-readable medium of claim 27 further comprising computer-readable program instructions adapted for:
providing a profile interface, wherein the information on the subscriber's viewing preferences is received from the subscriber accessing the profile interface.

30. The computer-readable medium of claim 27, wherein the information on the subscriber's viewing preferences is based on historical program selection data of the subscriber.

31. The computer-readable medium of claim 27 further comprising computer-readable program instructions adapted for:
assigning a correlation score to each identified group of the one or more groups, the correlation score represents a quantitative measure of correlation the subscriber's viewing preferences has with the particular identified group's viewing preferences; and
selecting at least the second content item from the available content items stored in the memory based on the second scores associated with the second records in the group preference table and the correlation score for each group of the identified groups.
